(19) United States
(12) Patent Application Publication
(10) Pub. No.: US 2013/0041738 A1
(43) Pub. Date: Feb. 14, 2013

(54) SYSTEMS AND/OR METHODS FOR IMPLEMENTING A CUSTOMER SAVINGS MERIT PROGRAM

(71) Applicants: Peter J. JUNGER, Redmond, WA (US); Kristin SECRETO, Kirkland, WA (US)

(72) Inventors: Peter J. JUNGER, Redmond, WA (US); Kristin SECRETO, Kirkland, WA (US)

(73) Assignee: Nintendo of America Inc., Redmond, WA (US)

(21) Appl. No.: 13/571,642

(22) Filed: Aug. 10, 2012

Related U.S. Application Data
(60) Provisional application No. 61/522,966, filed on Aug. 12, 2011.

(51) Int. Cl. G06Q 30/02

(52) U.S. Cl. 705/14.27

(57) ABSTRACT

Certain exemplary embodiments relate to techniques for facilitating a joint supplier/retailer driven customer loyalty program that specifically advocates customer loyalty by reaching out to consumers with offers that are relevant to the individual shopper and a particular experience they have had. A link between a product and/or service, and a specific customer is provided, e.g., to help facilitate the offering of an incentive (e.g., in the form of a voucher) to a customer who has had a less than satisfactory experience with a particular brand, product, service, sales experience, etc. An opportunity to repair the relationship with a customer who might otherwise be dissatisfied with a product or experience is provided through the provision of customizable customer savings merit programs.

### CROSS-REFERENCE TO RELATED APPLICATION

This application claims the benefit of U.S. Application Ser. No. 61/522,966, filed on Aug. 12, 2011, the entire contents of which are hereby incorporated by reference herein.

### TECHNICAL FIELD

Certain exemplary embodiments relate to techniques for facilitating a joint supplier/retailer driven customer loyalty program that specifically advocates customer loyalty by reaching out to consumers with offers that are relevant to the individual shopper and a particular experience they have had. In certain instances, a program may be implemented in order to help suppliers and retailers identify less than satisfactory customer experiences and proactively respond to exploit the immediate opportunity to turn discontented customers into social retailer/brand advocates.

### BACKGROUND AND SUMMARY

Currently, when a customer attempts to return a product (e.g., back to a store or retailer) and the item is refused or declined by the store, there are no all-encompassing follow-up procedures and/or mechanisms in place that would help a manufacturer compensate or appease a customer for their inconvenience of carrying or shipping their branded product back to a retailer and having it refused.

Furthermore, when a customer returns a true-defective product (e.g., to a retailer or store), the product oftentimes will be returned to the manufacturer or a liquidator, where the product is inspected, functionally tested, and possibly refurbished and eventually resold into a secondary market. Unfortunately, however, a large amount of time typically elapses (oftentimes one to three months) from when the product is returned to when it is eventually inspected/tested. It therefore is often difficult or even impossible to link a particular product to the original customer who was burdened with the expense and inconvenience of returning the product that was found to be defective.

Thus, it will be appreciated that it would be desirable to help address often-hidden customer points of dissatisfaction, while also providing a conduit to the manufacturer and/or to the retailer to identify and reach out to specific customers that have encountered unfavorable experiences with their brand, store, product, etc. It also will be appreciated that it would be desirable to link a specific end-customer with the product that has been returned when a product is found to be defective, damaged, or otherwise unusable or unwanted.

Certain exemplary embodiments may augment an existing loyalty program or reside as an exclusive standalone program so as to meet these and/or other needs. In certain exemplary embodiments, customer incentives awards (e.g., vouchers or points, monetary discounts, coupons, etc.) may be provided for specific experiences that customers encounter with a product, brand, retailer store, etc. Traditional loyalty programs typically award customers based on sales volume and/or shopping frequency. However, in certain exemplary embodiments, the target of the award may be based on “unfavorable” experiences. Thus, it may be possible in certain cases to establish or restore a customer's confidence in a product, brand, retailer that has sold the product, etc., and to retain and attract new customers via these unanticipated incentive offerings. It also may be possible to link an end-customer with the product that has been returned when a product is found to be truly defective, damaged, or otherwise unusable or unwanted using the techniques of certain exemplary embodiments.

One aspect of certain exemplary embodiments relates to providing a link between a product and a specific customer that may be stored separately in a central or other database. This may be facilitated, for example, by linking a unique identifier of a product (e.g., a product UPC and serial number combination, RFID/EPC, electronic serial number, etc.) with a customer identification number in an electronic registration (ER) database. In certain instances, customer information may be stored separately from product sale and/or return/warranty information so as to help maintain the privacy of the individual customers.

Another aspect of certain exemplary embodiments relates to enabling a manufacturer to offer an incentive (e.g., in the form of a voucher) to a customer who had a less than satisfactory experience with their brand/product/etc.

Still another aspect of certain exemplary embodiments relates to providing an opportunity to a retailer to repair its relationship with a customer who might otherwise be dissatisfied with a product or experience.

Examples of unfavorable experiences may include, for example, when a customer has to return an item back to a store/manufacturer (or online) because of a manufacturer defect and the item has proven true-defective after inspection and/or functional testing (manufacturer defect); when a customer attempts to return an item to a store (or online) and the store declines the return request; when an item malfunctioned and required a repair; when an item (product) was part of a manufacturer recall due to defects and/or safety concerns; when a customer voiced a legitimate complaint and/or had an unfavorable experience via a manufacturer's, retailer, or third party, customer support call-center; and/or other experiences where the manufacturer and/or the retailer determines that a customer is entitled to an incentive award.

In certain exemplary embodiments, a customer relationship management method is provided. Entries corresponding to negative experiences encountered by customers are maintained in a database of a computer system. Each said entry has associated therewith (a) a unique identifier of a product or service associated with the respective negative experience, (b) an identifier of the customer who had the respective negative experience, and (c) an indication as to what the negative experience was. A determination is made, in connection with at least one processor of the computer system, as to whether an award should be generated for a given customer who has experienced a negative experience based on whether that given customer qualifies for one or more predefined customer savings merit programs. When the award should be generated for the given customer, for each customer savings merit program for which the given customer qualifies, in connection with the at least one processor: aspects of the award are determined in dependence on the respective customer savings merit program; an electronic chit indicative of the determined aspects of the award is generated; the electronic chit is stored in a repository, with the repository being consultable for validation purposes in connection with an attempted redemption of the award; and the given customer is provided with the ability to redeem the award in accordance with the determined aspects. The determined aspects in some cases may be tailored as a specific response to a negative experience suffered by the given customer.

In certain exemplary embodiments, a customer relationship management system is provided. Processing resources include at least one processor and a memory. A database stores entries corresponding to negative experiences encountered by customers, with each said entry having associated therewith (a) a unique identifier of a product or service associated with the respective negative experience, (b) an identifier of the customer who had the respective negative experience, and (c) an indication as to what the negative experience was. At least one user interface is configured to enable authorized users to generate entries to be stored in the database. The processing resources are configured to determine whether an award should be generated for a given customer who has experienced a negative experience based on whether that given customer qualifies for one or more predefined and activated customer savings merit programs and, when the award should be generated for the given customer, for each customer savings merit program for which the given customer qualifies, the processing resources are configured to perform a number of follow-up procedures. These procedures may include determining aspects of the award in dependence on the respective customer savings merit program; generating an electronic chit indicative of the determined aspects of the award; storing the electronic chit in a repository, with the repository being consultable for validation purposes in connection with an attempted redemption of the award; and providing the given customer with the ability to redeem the award in accordance with the determined aspects. The determined aspects may include information concerning a value of the award, when the award can be used, and/or what the award can be used for.

In certain exemplary embodiments, non-transitory computer readable storage medium store thereon computer code comprising instructions that correspond to the methods described herein.

It will be appreciated that these features, aspects, advantages, and embodiments may be combined in various combinations and sub-combinations to achieve yet further exemplary embodiments.

### BRIEF DESCRIPTION OF THE DRAWINGS

These and other features and advantages will be better and more completely understood by referring to the following detailed of exemplary illustrative non-limiting implementations in conjunction with the drawings, of which:

FIG. 1 is a flowchart showing an illustrative process for offering customer savings merit program rewards, in accordance with certain exemplary embodiments;

FIG. 2 shows an example voucher that may be created in accordance with certain exemplary embodiments;

FIG. 3 is a flowchart showing an illustrative process for implementing voucher redemption, in accordance with certain exemplary embodiments; and

FIG. 4 is a schematic view of a system that may be used to implement the customer savings merit program techniques of certain exemplary embodiments.

### DETAILED DESCRIPTION

Certain exemplary embodiments relate to techniques for facilitating a joint supplier/retailer driven customer loyalty program that specifically advocates customer loyalty by reaching out to consumers with offers that are relevant to the individual shopper and a particular experience they have had. In certain instances, a program may be implemented in order to help suppliers and retailers identify less than satisfactory customer experiences and proactively respond to exploit the immediate opportunity to turn discontented customers into social retailer/brand advocates.

Certain exemplary embodiments provide a link so that a manufacturer and retailer may collaborate to help appease their mutual customers, e.g., in an attempt to restore their brand and reputation. Such situations may come into play, for example, when a customer successfully returns an item to a brick-and-mortar store, e-tailer store, or manufacturer, and the item is determined to be a true-defective or suffer from a manufacturing defect (e.g., after inspection and/or functional testing); when a customer attempts to return an item and the store declines the return; when an item malfunctions and requires a repair; etc.

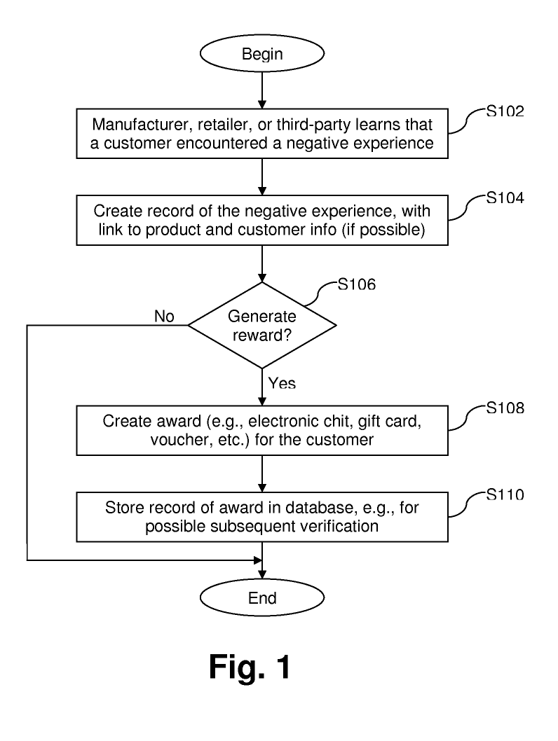

FIG. 1 is a flowchart showing an illustrative process for offering customer savings merit program rewards, in accordance with certain exemplary embodiments. When a manufacturer, retailer, or third-party (e.g., acting on behalf of a manufacture, retailer, or other) learns that a customer encountered one or more negative experiences (step S102), the incident may be posted to a central database. In this regard, a record may be created (step S104), with the record possibly including some or all of: applicable product information (e.g., UPC number, product description, model number, serial number, RFID/EPC number, electronic serial number, etc.), customer name or identifying information (if available) or other information linked to a specific customer, an indication of the negative experience (which may be selected from a predefined list of options or custom specified in some instances), etc. In certain cases, the retailer and/or the manufacturer may not know the consumer identity and therefore may only post the product with its associated unique identifier such as, for example, product serial number, EPC/RFID, or other identifier “license plate” number that the item was tagged with when it was received. The database may include transaction information linking the product's unique identifier with the customer ID. A determination is made as to whether a specific reward should be generated for the customer (step S106), e.g., in accordance with a predefined promotion or other program offered by the retailer, manufacturer, logistics provider, other party, and/or on their behalf/behalves. If so, an award (e.g., an electronic or physical chit, voucher, gift card, etc.) may be created and posted to the account of the customer (step S108). For instance, a voucher associated with an electronic chit or the like may include a barcode or other machine-readable code that embeds at least an electronic pointer to the electronic chit. The award may list at least what the voucher is applicable to, a monetary value, and/or a time limitation (e.g., 1 hour, 1 day, 1 week, 1 month, date range, etc.), and some or all of this data may be printed on the voucher in human readable format and/or embedded in the machine-readable code. A record of the creation of the award is stored in database (step S110), e.g., for possible subsequent verification, validation, and/or other purposes. The record may include, for example, some or all of the above-identified and/or other information.

An approval process or step may be provided in certain instances. A retailer to be made aware of a manufacturer promotion that may apply and, based on such information, the retailer may be able to approve or disapprove of the start or activation of a particular promotion. Of course, in certain instances, the inverse may also apply, and a retailer may run a promotion that the manufacturer can approve or disapprove. In still other cases, the retailer, manufacturer, and/or other parties may all run promotions that the other parties may or may not elect to participate in. This approval process or step may be performed as a part of the step S106 determination shown in and described in connection with FIG. 1, or before or after it, in different exemplary embodiments.

In certain cases, a promotion may be initiated automatically, e.g., once a certain number of complaints of a certain type and/or for a certain product are received. For instance, once complaints are posted for a threshold number or percentage of products, a promotion may be automatically triggered and thus become active. The database may classify the complaints into defined categories to facilitate this sort of tracking A plurality of policies may be predefined and be initiated automatically, e.g., at different levels or numbers of complaints in certain instances. In other instances, promotions may be started manually. In either case, an interface to the database over a network may be provided so that the relevant parties can define some or all of the parameters of the promotions, start/stop promotions, etc.

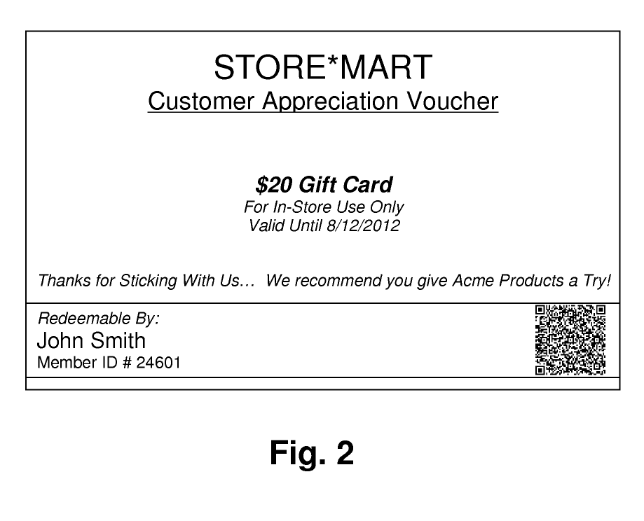

When a certain condition is met, a voucher may be generated and issued to customers who qualify for it. An example voucher is shown in FIG. 2. The voucher may be in an electronic or printed form, and may have indicia of its value (e.g., in terms of dollars of other currency, points, etc.). The awards may be made available for redemption immediately, at a later date/time, contingent on other purchases, etc. A post may be made to the database to reflect the voucher's proper awards value (whether that be expressed in points, amount of discount, coupons, etc.) so that rewards can be tracked and so that the likelihood of potential fraud associated therewith (e.g., from copying, false claims, multiple uses, etc.) may be reduced (e.g., as noted above in connection with step S110 in FIG. 1). The amount of the award may be based on the manufacturer posted or contractual predetermined dollar amount and/or the specific experience the customer encountered. For instance, a formula may be defined in accordance with a contractual agreement. The formula may involve a weighted combination of terms such as, for example, number of times a or the problem happened for a customer, the severity of the problem(s), the amount the product cost, etc. These factors may be linear or non-linear weights. For instance, a customer who has encountered a number of problems may have an increasing weight. On the other hand, if it appears that the customer is abusing the program (e.g., by making a number of claims that are suspect in terms of type, quantity, value, etc.), the rewards may then be reduced or excluded. In certain exemplary embodiments, a negative quadratic value may be applied so as to help protect against this situation, with the maximum point of the quadratic graph being at a predetermined threshold value (in terms of dollar amount, number of problems, etc.). The voucher may include consumer- and/or problem-specific messages. For instance, if a consumer (or multiple consumers) had an issue with Brand X, the program may recognize this and suggest an alternate brand, etc.

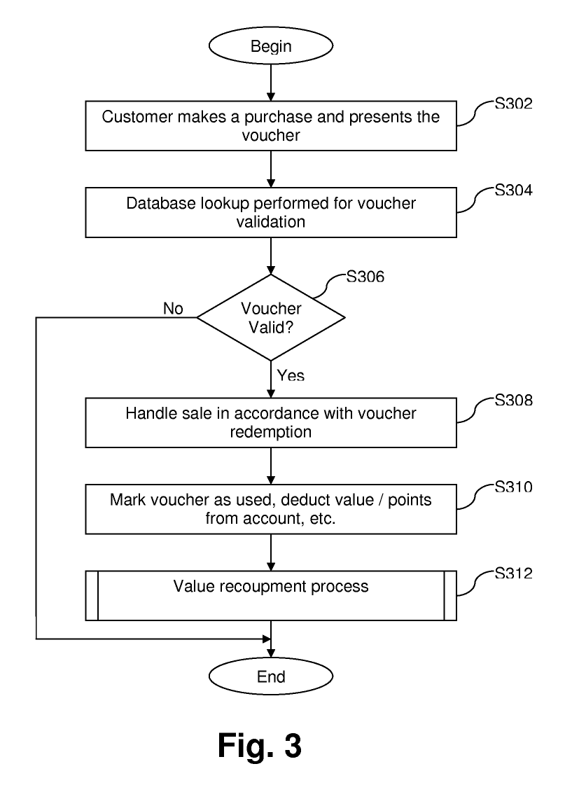

FIG. 3 is a flowchart showing an illustrative process for implementing voucher redemption, in accordance with certain exemplary embodiments. In terms of voucher redemption, the customer may make a purchase and present the voucher (e.g., in person or through a suitable user interface area in an online purchasing system) in step S302. In some cases, the register may initiate a prompt for “voucher available” and/or “voucher value” (e.g., at the end of the transaction). In other instances, a voucher identifier may be scanned (e.g., as if it were a coupon or the like). In other words, purchased items may be scanned along with the voucher presented by the customer in other cases. A lookup to the database (e.g., by a point-of-sale system or register, online purchasing system, etc.) may be initiated to validate the voucher in step S304. This validation process may include, for example, determining whether the voucher is active, whether eligibility conditions have been met (e.g., if it can only be used at a certain store, to buy or replace a particular product, within a certain time window, etc.), how much value is to be conveyed, etc. If all conditions are met (e.g., as determined in step S306), voucher value may be applied and deducted from the customer's total amount, or another suitable action may be taken, in step S308. In step S310, the voucher may be marked as used, its value or a corresponding number of points may be deducted from the customer's account, etc.

In certain exemplary embodiments, the customer may be asked to present identification (e.g., a driver's license or program-specific card) to access the earned points or value. In other cases, credit or debit cards may provide a suitable verification and link, and for privacy reasons, related information may be hashed and the corresponding output stored in a database.

After the voucher is redeemed, an invoice may be generated to recoup the value of the voucher from the manufacturer (or a specific retailer department, if the voucher was issued by the retailer) in step S312. The third party managing the database may facilitate the voucher reconciliation and/or generating the invoice, potentially for a fee. For instance, a third party may take a percentage of the sale (e.g., 1%, 2%, etc.) or a fixed agree-to amount. In different embodiments, billing between the retailer and supplier/manufacturer may be direct, a deduction from an invoice (e.g., a charge-back), or through an intermediary such as the third party. This recoupment process may be transparent to the consumer in some instances.

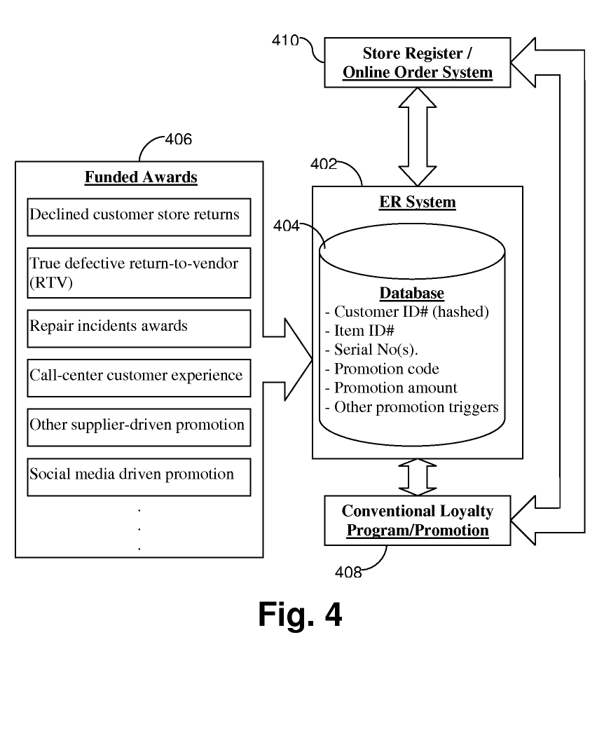

The FIG. 4 diagram provides an overview of an illustrative system in accordance with certain exemplary embodiments. It is noted that the ER system 402 described in greater detail below may include one or more processors and a non-transitory computer readable storage medium tangibly storing the ER database 404. In certain instances, the ER database 404 may be multiple databases, multiple tables within one or more databases, etc. The funded awards 406 may be manufacturer or retailer funded, or shared cost awards. The funded awards 406 may have definitional information associated therewith including program eligibility requirements such as, for example, criteria concerning certain classes of consumers who can access the program (registered users only, all consumers, consumers who have bought a particular product or brand within a certain timeframe, etc.), specific problems that the program is directed to resolve or address, specific places and/or parties that may trigger the program (e.g., certain preferred retailers, distributers, manufacturers), etc. Additional definitional information such as, for example, what the award/reward is, when/how it can be redeemed or used, what it can be deemed on, etc., also may be specified. Criteria for calculating award/reward amounts also may be specified, as may an overall “pot” devoted for a particular program (e.g., such that the program is discontinued after its “pot” has been used up), etc. Flags may be stored to indicate whether relevant business partners have approved a particular program (e.g., a retailer may seek manufacturer approval for a particular program, and vice versa). The conventional loyalty programs/promotions 408 similarly may be manufacturer or retailer funded, or shared cost programs/promotions. These and/or other awards may be defined via respective user interfaces accessible by authorized users via suitable configured computers. Furthermore, multiple more conventional loyalty programs/promotions may be provided, which may or may not be in communication with the ER system 402 and/or the funded awards system as a whole.

As alluded to above, interfaces may be provided to authorized parties (manufacturers, retailers, etc.), so as to help define the parameters of the various awards and/or programs. These interfaces may provide restricted access to the data in the ER database 404. For instance, manufacturers and retailers may be blocked from seeing customer information, or information about other competitor manufacturers or retailers. Manufacturers may have access to retailer information only if they are designated partners in certain cases, and vice versa. It will be appreciated that the funded awards shown in FIG. 4 are provided by way of example. The interfaces may be accessible over a network, e.g., via a computer. In certain cases, a client computer may connect to one or more server computer(s) administering the funded awards 406 and/or conventional loyalty program/promotions. The interfaces may be used to provide the definitional and/or other information relevant to a particular program. A store register, online order system, or the like 410 may have access to the ER system 402, the conventional programs 408, etc., which may be useful in known ER techniques, as well as in the administration/management of, and/or cooperation with, the exemplary funded award program techniques described herein.

There are a number of possible situations that might trigger the generation of a voucher and/or cause an entry in the database system for possible consideration as to whether to count the “bad experience” towards generation of a future voucher. These situations may include, for example:
1. True defective return-to-vendor (RTV)
2. Declined customer store returns
3. Repair incidents
4. When an item (product) is returned due to a manufacture defect recall
5. Call-center customer experience (manufacture, retailer, or third party)
6. Social media driven promotion
7. Supplier driven promotions
8. Retailer driven promotion
   Each of these example situations is discussed in greater detail below.

1. True Defective Return-to-Vendor (RTV): Accepting customer returns is a standard practice with retailers in the U.S., Canada, and certain other parts of the world. The reason behind these returns vary from consumer remorse, dissatisfaction, ease-of use, obsolescence, price erosion, fraud, true defective products, etc. Although some customer returns are justified (possibly about 10% to 30%), many of them are not. Because retailers find it difficult to substantiate it one way or the other, and in an effort to retain customers, retailers tend to be kindhearted and not squabble with their customers at great expense to the retailer and manufacturer. For those products ultimately returned to the manufacturer (RTV) and proven to be defective as determined through functional tests by the supplier or designated third party, consumers have been negatively impacted and inconvenienced. This leads to a tarnished reputation to the brand and to the retailer that sold the product to the customer. Salvaging and restoring the customer's confidence in the brand and the retailer would be desirable in such situations. Certain exemplary embodiments may thus help enable a manufacturer (and/or retailer) to accommodate the customer, potentially in a manner that helps restore credibility and/or reputation.

The supplier may submit the product's unique identifier (that has proven defective) to a database where the customer's award points or monetary value are posted to a customer account or associated with a identifier so that they are available for redemption at a later time (e.g., at the retailer, an e-tailer, for purchase of a similar product elsewhere, etc.). An appreciation email could also be sent to the customer on behalf of the supplier and/or retailer, thanking the customer for the continued support of the brand/retailer. The points/value updates may also be reflected on a future or next purchase and printed on the receipt.

2. Declined Customer Store/On-Line Returns: Many products returned to a retailer are found to be non-defective and are returned for other reasons. Some top reasons include: buyer's remorse, product obsolescence, a need for cash (or in-store credit), fraud, etc. It has been found that only a very small percentage of these returns actually require repair. When a product return is declined by a retailer, it could be advantageous to the retailer and the supplier (vendor/manufacturer) to accommodate the customer in some way. For instance, if a customer wants to return a Nintendo Wii but is declined because it was purchased more than six months ago, it would be advantageous for Nintendo to offer a note of gratitude (points/value) to the customer for keeping the Wii and to encourage future Nintendo product purchases, such as new game software. This approach may reduce the number of store manager overrides related to customer discontent and save the manufacturer and the retailer millions of dollars annually.

The retailer (through an ER service, for example) may forward the serial number or other unique identifier of a product to the database where a return attempt was made and the retailer declined it. The same techniques as in (1) above could be used. For instance, the database could post the customer's award points/value to the customer's account and makes them available for redemption at the retailer. An appreciation email could also be sent to the customer on behalf of the suppliers and retailer, thanking the customer for the continued support of the retailer and brand. The points/value updates would also be reflected on their next purchase and printed on their receipt.

3. Repair Incidents: When a product is indeed in need of repair, a customer is inconvenienced and endures benefit denial while the product is out being repaired. The reputation of a brand can be severely damaged by the way a company handles the interaction with the customer. For these reasons, a manufacturer may consider offering a note of gratitude (points/value) to their customer so as to help possibly regain a customer's confidence in the brand.

The supplier may forward to the database the product's unique identifier that has undergone repair by the supplier or their third-party Authorized Service Centers (ASC). The database may post the customer's award points/value on the customer's account and make them available for redemption at the retailer. As above, an appreciation email could also be sent to the customer on behalf of the supplier and retailer, thanking the customer for the continued support of the brand/retailer. The points/value updates could also be reflected on their next purchase and printed on their receipt.

4. When an item (product) is returned due to a manufacturer defect recall: See (1) above.

5. Call-Center Customer Experience: Companies (manufacturers and/or retailers) use Inbound Call Centers to assist customers with problems that range from technical problems to user questions to sales of accessories and peripherals. Strategic initiatives that award the customer for their perseverance in getting a resolution to their problem can improve the customer experience, enhance the relationship with the company, and set it apart from its competitors. In today's competitive marketplace, superior customer service is quickly becoming a brand differentiator.

The supplier's call center may forward to the database customer account information and/or the serial number (unique identifier) of the product. Similar to the above, the database may then post the customer's award points/value to the customer's account and make them available for redemption at the retailer. An appreciation email could also be sent to the customer on behalf of the supplier and retailer, thanking the customer for the continued support of the brand/retailer. The points/value updates could also be reflected on their next purchase and printed on their receipt.

6. Social Media Driven Promotions: A manufacturer/supplier could use a utility to reward current and/or new customers for social media leads (e.g., via Facebook, Twitter, LinkedIn, etc.), and/or for encouraging people to further promote their brand and/or a retailer. For instance, it may be possible to track “likes,” hash tags, recommendations, the social media equivalent of “word-of-mouth” or buzz, etc.

7. Supplier Driven Sales Promotions: Such promotions could take place during, for example, product launch (potentially offering complimentary specials or bundles on the fly); end-of-life product clearance specials; preemptive counter competitor specials; product recalls customer satisfaction award (e.g., for specific serial numbers or serial number ranges, batches, pallets, etc.), and/or the like.

The supplier may forward to the database customer account information and/or the serial number of products, along with the promotion type. Similar to the above, the database may post the customer's award points/value on the customer's account and make them available for redemption at the retailer. An appreciation email could also be sent to the customer on behalf of the supplier and retailer, thanking the customer for the continued support of the brand/retailer. The points/value updates could also be reflected on their next purchase and printed on their receipt.

These types of award promotions could be configurable by the offering party, and certain awards may be preapproved by the retailer. Others may require additional approval by the retailer and may be flagged via exception alerts and forwarded to the appropriate retailer contact, e.g., the buyer.

8. Retailer Driven Promotions: Certain exemplary embodiments may enable suppliers to link up with their retailer partners' systems to promote customer loyalty through individualized offerings. A black-box or more open approach may be provided, through which suppliers can partner with their retailers in delivering various rewards/promotions to their mutual customers.

The example transmissions described above may be made individually and/or in batch in different exemplary embodiments.

The following table includes a number of benefits and/or highlights for customers, retailers, and suppliers that may accompany the programs of certain exemplary embodiments.

| CUSTOMER | RETAILER | SUPPLIER |
|---|---|---|
| Additional savings | Know your customer | Improve brand loyalty |
| Additional perks | Retain customers | Improve customer |
| | | satisfaction |
| Additional buying | Attract new customers | Incremental sales |
| dollars | | |
| Greater product/ | Promote greater | Fewer returns |
| brand experience | spending | |
| Improve shopping | Improve customer | Data intelligence |
| experience | satisfaction | |
| Greater loyalty with | Improve sales and profit | Introduce customers to |
| retailer | | same brand new product |
| | | categories |
| | Lower prices for your | Precise warranty data |
| | customer | |
| | Increase net sales | Call center intelligence - |
| | | reduce talk-time and |
| | | improve customer |
| | | satisfaction |
| | Addresses manager | Turn unhappy customers |
| | Overrides | into social brand |
| | | advocates |
| | Identify and reduce | |
| | fraud | |
| | Unique services by | |
| | customer-class or | |
| | individual customer | |
| | Data intelligence | |
| | Increase shopping basket | |
| | Boost shopping | |
| | frequency | |
| | Improve store navigation | |
| | and customer awareness | |
| | of other store categories | |
| | Turn unhappy customers | |
| | into social retailer | |
| | advocates | |

Internet sales that are returned to brick-and-mortar stores may be linked via serial number or other unique identifier in certain instances, and a voucher from the proper party may be thus issued.

As alluded to above, a customer may have to enroll in the program and may obtain a program-specific account that can accumulate points or rewards. The ER system shown in and described in connection with FIG. 4 may, for example, maintain registration information, in certain exemplary embodiments. In certain other exemplary embodiments, the party or parties offering the promotion may maintain such registration information, and the ER system optionally may have access to some or all of this information (which may be needed in the issuance and/or validation of a particular award/reward). The rewards or points balance may be reflected on the receipts of qualifying purchases and/or when the customer is identified. Thus, retailers and/or manufacturers may proactively contact registered users in the event that a recall is necessary, that a large number of products have a known defect or problem, that a return/warranty request will likely be necessary, etc. In certain implementations, a customer may determine whether points are to be stored or used automatically at a next sale. In certain implementations, a retailer/manufacturer may determine whether points or rewards are tied to sales or percentages returned.

The techniques described in U.S. application Ser. No. 12/923,484 (filed Sep. 23, 2010) and/or Ser. No. 12/926,382 (filed Nov. 15, 2010) may be used to help reduce fraudulent transactions related to vouchers in certain exemplary embodiments. The entire contents of each of these applications is hereby incorporated herein by reference. Thus, another advantage of certain exemplary embodiments relates to the ability to link a product's unique identifier with a promotion/voucher to mitigate fraudulent return behavior. For example, if a customer receives and redeems a voucher and then attempts to return the original purchased item, the system may be configured to detect this behavior and alert the store associate that the customer should only be refunded the net amount from the purchase price, less the voucher amount. This may be accomplished by querying the database to determine whether the voucher is valid, and then searching the repository to determine the value of the voucher (e.g., if it is not known from the scanning of a code thereon). Similarly, if the customer attempts to return the originally purchased item without the voucher, the store associate may be alerted to either request the voucher be presented for return or, again, refund only the netted amount.

The ER database may be an ER database as described in, for example, U.S. Pat. Nos. 5,978,774; 6,018,719; and 6,085,172, the entire contents of which are hereby incorporated herein by reference.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A customer relationship management method, comprising:
maintaining, in a database of a computer system, entries corresponding to negative experiences encountered by customers, each said entry having associated therewith (a) a unique identifier of a product or service associated with the respective negative experience, (b) an identifier of the customer who had the respective negative experience, and (c) an indication as to what the negative experience was;
determining, in connection with at least one processor of the computer system, whether an award should be generated for a given customer who has experienced a negative experience based on whether that given customer qualifies for one or more predefined customer savings merit programs; and
when the award should be generated for the given customer, for each customer savings merit program for which the given customer qualifies, in connection with the at least one processor:
determining aspects of the award in dependence on the respective customer savings merit program,
generating an electronic chit indicative of the determined aspects of the award,
storing the electronic chit in a repository, the repository being consultable for validation purposes in connection with an attempted redemption of the award, and
providing the given customer with the ability to redeem the award in accordance with the determined aspects.

2. The method of claim 1, further comprising generating a printable voucher associated with each said generated electronic chit, the voucher including thereon indicia of at least some of the determined aspects.

3. The method of claim 1, wherein the determined aspects include information concerning a value of the award, when the award can be used, and what the award can be used for.

4. The method of claim 1, further comprising calculating a value for each award to be generated based on a formula involving a weighted combination of terms including a number of times the respective customer encountered a problem, a severity of the problem(s) encountered, and/or an amount the associated product or service cost.

5. The method of claim 1, wherein further comprising calculating a value for each award to be generated based on a formula including a negative quadratic function.

6. The method of claim 1, wherein entries in the database are creatable by the retailer and/or manufacturer via respective computer-mediated user interfaces in communication with the computer system.

7. The method of claim 1, further comprising linking the unique identifier of the product with the identifier of the customer who had the respective negative experience in connection with transaction information that uniquely identifies the customer, wherein personal information of the customer is not stored in the database.

8. The method of claim 1, further comprising classifying negative experiences as being one or more predefined problems selected from a list of predefined problems.

9. The method of claim 8, wherein the list of predefined problems is created by a retailer, manufacturer, or third-party during creation of the customer savings merit program(s).

10. The method of claim 1, wherein the determination as to whether an award should be generated for a given customer is practiced only for active customer savings merit programs.

11. The method of claim 10, further comprising activating customer savings merit programs once retailer-defined programs have been approved by any implicated manufacturers, and vice versa.

12. The method of claim 10, further comprising automatically activating customer savings merit programs once complaints are posted for a threshold number or percentage of products implicated by the respective program(s).

13. The method of claim 1, further comprising when a voucher is redeemed, initiating a recoupment process as between parties defined in the program associated with the voucher being redeemed.

14. A non-transitory computer readable storage medium storing thereon a computer code comprising instructions for:
maintaining, in a database of a computer system, entries corresponding to negative experiences encountered by customers, each said entry having associated therewith (a) a unique identifier of a product or service associated with the respective negative experience, (b) an identifier of the customer who had the respective negative experience, and (c) an indication as to what the negative experience was;
determining, in connection with at least one processor of the computer system, whether an award should be generated for a given customer who has experienced a negative experience based on whether that given customer qualifies for one or more predefined customer savings merit programs; and
when the award should be generated for the given customer, for each customer savings merit program for which the given customer qualifies, in connection with the at least one processor:
determining aspects of the award in dependence on the respective customer savings merit program, the determined aspects being tailored as a response to a negative experience suffered by the given customer.
generating an electronic chit indicative of the determined aspects of the award,
storing the electronic chit in a repository, the repository being consultable for validation purposes in connection with an attempted redemption of the award, and
providing the given customer with the ability to redeem the award in accordance with the determined aspects.

15. A customer relationship management system, comprising:
processing resources including at least one processor and a memory;
a database storing entries corresponding to negative experiences encountered by customers, each said entry having associated therewith (a) a unique identifier of a product or service associated with the respective negative experience, (b) an identifier of the customer who had the respective negative experience, and (c) an indication as to what the negative experience was; and
at least one user interface configured to enable authorized users to generate entries to be stored in the database,
wherein the processing resources are configured to determine whether an award should be generated for a given customer who has experienced a negative experience based on whether that given customer qualifies for one or more predefined and activated customer savings merit programs and, when the award should be generated for the given customer, for each customer savings merit program for which the given customer qualifies:
determine aspects of the award in dependence on the respective customer savings merit program,
generate an electronic chit indicative of the determined aspects of the award,
store the electronic chit in a repository, the repository being consultable for validation purposes in connection with an attempted redemption of the award, and
provide the given customer with the ability to redeem the award in accordance with the determined aspects, and
wherein the determined aspects include information concerning a value of the award, when the award can be used, and/or what the award can be used for.

16. The system of claim 15, wherein the processing resources are further configured to calculate a value for each award to be generated based on either or both of:
a formula involving a combination of terms including a number of times the respective customer encountered a problem, a severity of the problem(s) encountered, and/or an amount the associated product or service cost, the terms being weighted in accordance with predefined weights; and
a negative quadratic function.

17. The system of claim 15, wherein:
the database is configured to link the unique identifier of the product with the identifier of the customer who had the respective negative experience in connection with transaction information that uniquely identifies the customer; and
personal information of the customer is not stored in the database.

18. The system of claim 15, wherein the database is configured to store information classifying negative experiences as being one or more predefined problems selected from a list of predefined problems, the list of predefined problems being created by a retailer, manufacturer, or third-party during creation of the customer savings merit program(s).

19. The system of claim 15, wherein customer savings merit programs are to be considered activated by the system once retailer-defined programs have been approved by any implicated manufacturers, and vice versa and/or are automatically activated once complaints are posted for a threshold number or percentage of products implicated by the respective program(s).

20. The system of claim 15, wherein the processing resources are further configured to coordinate the transfer of funds as between parties defined in a customer savings merit program associated with an award that has been redeemed by a customer that has been validated, the transfer of funds being performed in connection with contractual terms specified in the associated program.
